(19) United States
(12) Patent Application Publication
(10) Pub. No.: US 2009/0190824 A1
(43) Pub. Date: Jul. 30, 2009

(54) Inspection apparatus and inspection method

(75) Inventors: Kosuke Niimura, Obu-city (JP); Yoshio Yokoyama, Anjo-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/319,831

(22) Filed: Jan. 13, 2009

(30) Foreign Application Priority Data
Jan. 16, 2008 (JP) 2008-006942

(51) Int. Cl. G06K 9/00

(52) U.S. Cl. 382/141

(57) ABSTRACT

An inspection apparatus according to the present invention comprises: a one-dimensional imaging unit for imaging a workpiece which is a three-dimensionally shaped test object; a first lens for causing light incident thereon from the test object to emerge as converging light; and a second lens, disposed between the first lens and the one-dimensional imaging unit, for focusing the light emerging from the first lens, wherein a chief ray of a bundle of rays incident on the first lens from the test object is parallel to the optical axis of the first lens, and the light containing the chief ray, incident from the test object, is focused through the first lens and the second lens onto the one-dimensional imaging unit for imaging.

The Applicant claims the right to priority based on Japanese Patent Application JP 2008-006942, filed on Jan. 16, 2008, and the entire content of JP 2008-006942 is hereby incorporated by reference.

### BACKGROUND OF THE INVENTION

1. Field of the Invention

The present invention relates to an inspection apparatus and an inspection method. More particularly, the invention relates to an inspection apparatus and an inspection method for inspecting the surface or appearance of a test object having a three-dimensional shape containing raised and recessed portions.

2. Description of the Related Art

Conventionally, an inspection apparatus has been used to inspect the surface or appearance of a test object such as a product or a component. This kind of inspection apparatus comprises a camera, etc., and is operated, for example, to capture an image of the surface of the product or component by the camera and to judge the quality acceptability of the product or component based on the captured image.

Some test objects have a two-dimensional shape, and some have a three-dimensional shape with raised and recessed portions. In the case of a test object having a three-dimensional shape with raised and recessed portions, shadows may be formed on the surface of the test object, or there may occur areas that are hidden behind the raised portions and not captured by the camera.

Japanese Patent No. 3170598 and Japanese Patent No. 3580493, for example, disclose a surface inspection apparatus having an ingeniously designed illumination unit for illuminating a test object with parallel rays of light.

However, the surface inspection apparatus disclosed in Japanese Patent No. 3170598 and Japanese Patent No. 3580493 involves the problem that there occur areas that are hidden behind raised portions on the test object and that are not captured by the camera, depending on the field of view of the camera and lens, as shown in FIG. 1.

FIG. 1a is a diagram for explaining an essential portion of an inspection process that uses a surface inspection apparatus according to the related art. In the surface inspection apparatus shown in FIG. 1a, a camera 111 captures an image of the surface of a test object 120 through a focusing lens 114.

The camera 111 has a field of view, α, centered about an optical axis L via the lens 114, and can capture an image of the test object 120 placed within the field of view. In the example of FIG. 1a, a pair of test objects 120 and 120 are placed near the left and right edges, respectively, within the field of view.

Each test object 120 has a three-dimensional shape with a recessed portion in the center flanked on both sides by raised portions.

In FIG. 1b, each arrow indicates the direction of the chief ray propagating at an angle relative to the optical axis L from the test object 120 toward the camera 111. The reflected light from the test object 120 is focused through the lens 114 onto the camera 111 for imaging.

However, as shown in FIG. 1b, the reflected light from a restricted region Q in the recessed portion of the test object 120 is obstructed by one of the raised portions and may not be focused through the lens 114 onto the camera 111.

As shown in FIG. 1c, the image captured by the camera 111 contains the interior region Q1 of the raised portion of the test object 120, but the image of the restricted region Q in the recessed portion is not captured.

As a result, if there is a defect in the region Q of the test object 120, the surface inspection apparatus shown in FIG. 1 may erroneously judge that the test object 120 is free from defects.

The surface inspection apparatus shown in FIG. 1 has the further problem that, because of the limited range of the field of view of the camera 111, the region Q varies depending on where in that limited range the test object 120 is placed. This means that the quality judgment accuracy of the surface inspection apparatus varies depending on the position at which the test object is placed.

### SUMMARY OF THE INVENTION

The present invention aims to solve the above problem, and an object of the invention is to provide an inspection apparatus and an inspection method that can inspect a three-dimensionally shaped test object. It is another object of the invention to provide an inspection apparatus and an inspection method that can accurately inspect a test object having a three-dimensional shape containing raised and recessed portions. It is a further object of the invention to provide an inspection apparatus and an inspection method that can accurately inspect a three-dimensionally shaped test object without being affected by the position at which the test object is placed.

To solve the above problem, an inspection apparatus according to the present invention comprises: a one-dimensional imaging unit (11) for imaging a three-dimensionally shaped test object (20); a first lens (12) for causing light incident thereon from the test object (20) to emerge as converging light; and a second lens (14), disposed between the first lens (12) and the one-dimensional imaging unit (11), for focusing the light emerging from the first lens (12), wherein a chief ray of a bundle of rays incident on the first lens (12) from the test object (20) is parallel to an optical axis of the first lens (12), and the light containing the chief ray, incident from the test object (20), is focused through the first lens (12) and the second lens (14) onto the one-dimensional imaging unit (11) for imaging.

With the above configuration, the test object having a three-dimensional shape with raised and recessed portions can be accurately inspected. Further, the three-dimensionally shaped test object can be accurately inspected without being affected by the position at which the test object is placed. Furthermore, the use of the one-dimensional imaging unit not only facilitates the adjustment of the optical axis, but also serves to reduce the manufacturing cost of the apparatus while reducing the size of the imaging unit. Moreover, it becomes easier to obtain an imaging unit having high resolving power.

Preferably, in the inspection apparatus according to the present invention, the first lens (12) is a Fresnel lens.

This serves to reduce the size, weight, and cost of the first lens.

Preferably, in the inspection apparatus according to the present invention, the one-dimensional imaging unit (11) is constructed from a plurality of imaging elements arrayed in a straight line, and the first lens (12) is formed in an oblong shape whose longitudinal length extends in a direction that coincides with the direction in which the plurality of imaging elements are arrayed in the one-dimensional imaging unit (11).

This serves to reduce the amount of deflection of the first lens, the resulting effect being that the image captured by the one-dimensional imaging unit becomes less susceptible to distortion associated with such deflection.

Preferably, in the inspection apparatus according to the present invention, the longitudinal length of the first lens (12) is greater than the longitudinal length of an inspection portion of the test object (20) placed on the surface inspection apparatus (10).

With this arrangement, the inspection portion extending in the longitudinal direction of the three-dimensionally shaped test object can be inspected in a reliable manner without being affected by the position at which the test object is placed.

Preferably, the inspection apparatus according to the present invention further comprises a pair of illumination units (13, 13) each having an oblong shape, and the pair of illumination units (13, 13), whose longitudinal direction is oriented so as to coincide with the longitudinal direction of the first lens (12), is arranged between the first lens (12) and the test object (20) so as to illuminate the test object (20) obliquely from above.

With this arrangement, since the test object can be evenly illuminated, the test object having a three-dimensional shape with raised and recessed portions can be inspected further accurately.

Preferably, the inspection apparatus according to the present invention further comprises a transport unit (15) for transporting the test object (20) placed thereon, wherein the transport unit (15) transports the test object (20) in a direction transverse to the direction in which the plurality of imaging units are arrayed, and the one-dimensional imaging unit (11) successively captures images of the test object (20) being transported.

With this arrangement, the one-dimensional imaging unit can successively capture strip-like images of the test object while the test object is being transported by the transport unit.

Preferably, in the inspection apparatus according to the present invention, the optical axis of the one-dimensional imaging unit (11) coincides with the optical axis of the first lens (12).

With this arrangement, the inspection apparatus can be constructed with a reduced number of optical elements.

According to the present invention, there is also provided an inspection method, wherein: light from a three-dimensionally shaped test object (20), the light being such that a chief ray of a bundle of rays incident on a first lens (12) from the test object (20) is parallel to the optical axis of the first lens (12), is caused to enter the first lens (12) which causes the light incident thereon from the test object (20) to emerge as converging light; the light emerging from the first lens (12) is caused to enter a focusing second lens (14); the light emerging from the second lens (14) is caused to enter a one-dimensional imaging unit (11); the light entering the one-dimensional imaging unit (11) is converted into an image; and quality acceptability of the test object (20) is judged by using the image captured by the one-dimensional imaging unit (11).

With this method, the test object having a three-dimensional shape with raised and recessed portions can be accurately inspected.

Preferably, in the inspection method according to the present invention, an image representing the entirety of the test object (20) is synthesized from a plurality of strip-like images captured by the one-dimensional imaging unit (11), and the quality acceptability of the test object (20) is judged by using the synthesized image.

With this arrangement, the quality acceptability of the test object can be judged by using a single image synthesized to show the entire test object.

The parenthesized numerals appended to the above-described means correspond to the numerals used to designate the corresponding means in the embodiment described hereinafter.

### BRIEF DESCRIPTION OF THE DRAWINGS

These and other features and advantages of the present invention will be better understood by reading the following detailed description taken together with the drawings, wherein:

FIG. 1a is a diagram for explaining an essential portion of an inspection process that uses a surface inspection apparatus according to the related art.

FIG. 1b is a diagram showing the direction of a chief ray.

FIG. 1c is a diagram showing an image captured by a camera in the apparatus of FIG. 1a.

FIG. 2a is a diagram showing the configuration of a surface inspection apparatus according to one embodiment of the present invention.

FIG. 2b is a diagram for explaining an arrangement of a pair of illumination units in FIG. 2a.

FIG. 3a is a diagram for explaining an essential portion of an inspection process that uses the embodiment of FIG. 2.

FIG. 3b is a diagram showing the direction of a chief ray.

FIG. 3c is a diagram showing an image captured by a one-dimensional imaging unit.

FIG. 4a is a diagram for explaining the characteristic of a first lens in the embodiment.

FIG. 4b is a diagram for explaining the case where a lens having a large area is used.

FIG. 5 is a flowchart for explaining one operational example of the embodiment of FIG. 2a.

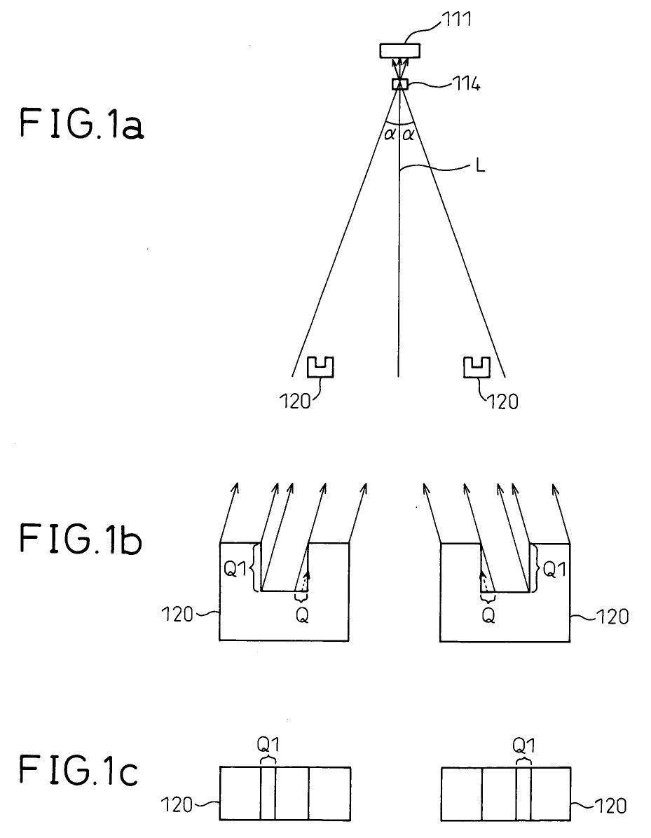

### DETAILED DESCRIPTION OF THE PREFERRED EMBODIMENT

An inspection apparatus according to the present invention will be described below based on one preferred embodiment thereof with reference to the accompanying drawings.

However, note that the present invention is not limited by the following explanation but it extends to the aspects of the invention described in the claims and their equivalents.

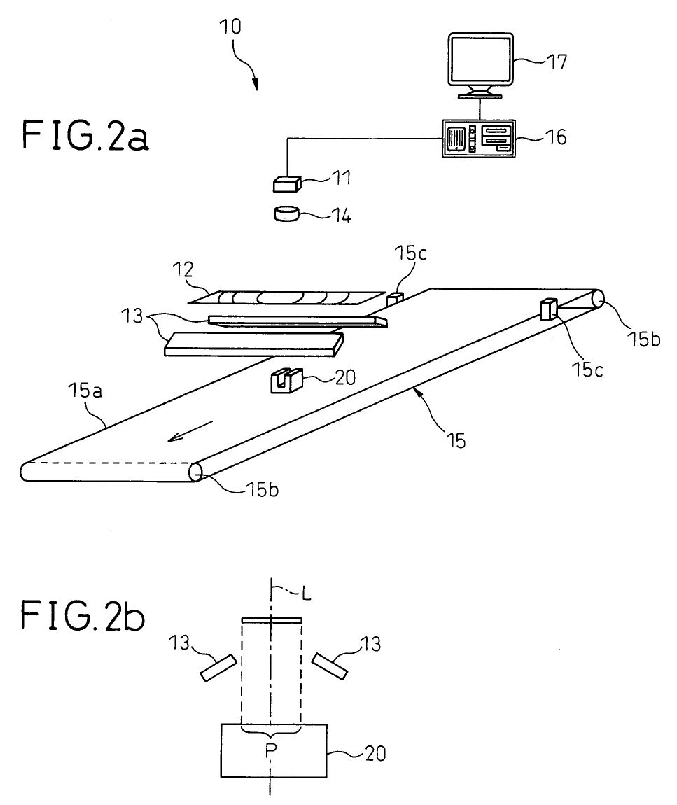

The surface inspection apparatus 10 (hereinafter sometimes referred to simply as the apparatus 10) of the present embodiment comprises, as shown in FIG. 2a, a one-dimensional imaging unit 11 for imaging a workpiece 20 which is a three-dimensionally shaped test object, a first lens 12 for causing light incident thereon from the test object 20 to emerge as converging light, and a second lens 14, disposed between the first lens 12 and the one-dimensional imaging unit 11, for focusing the light emerging from the first lens 12. In the apparatus 10, the chief ray of a bundle of rays incident on the first lens 12 from the test object 20 is parallel to the optical axis of the first lens 12, and the light containing the chief ray, incident from the workpiece 20, is focused through the first lens 12 and the second lens 14 onto the one-dimensional imaging unit 11 for imaging.

Here, the light containing the chief ray, incident from the workpiece 20, refers not only to light emitted from an external light source and reflected by the workpiece 20 but also to light transmitted through the workpiece 20 which, in this case, is a transparent object.

In the apparatus 10, the optical axis of the one-dimensional imaging unit 11 coincides with the optical axis of the first lens 12. The first and second lenses 12 and 14 together constitute a focusing optical system for focusing the image of the workpiece 20 onto the one-dimensional imaging unit 11.

Further, the apparatus 10 comprises, in addition to the second lens 14 disposed in the light path between the first lens 12 and the one-dimensional imaging unit 11 and movable along the optical axis so as to focus the image onto the one-dimensional imaging unit 11, a pair of illumination units 13 and 13 for illuminating the workpiece 20, a transport unit 15 for transporting the workpiece 20 placed thereon, an image processing unit 16 for receiving an image signal from the one-dimensional imaging unit 11 and for performing image processing to judge the quality acceptability of the workpiece 20, and a display unit 17 for displaying an output of the image processing unit 16. The image processing unit 16 includes a control unit (not shown) which controls the various component elements of the apparatus 10.

The workpiece 20 to be inspected by the apparatus 10 has a three-dimensional shape with raised and recessed portions, as shown in FIG. 2a. The workpiece 20 here is formed from an opaque material. In the apparatus 10, the entire surface of the workpiece 20 may be inspected, or a portion or a plurality of portions of the surface of the workpiece 20 may be inspected. Further, when the workpiece 20 is constructed by assembling a plurality of components, the placement of the fasteners such as bolts or connectors used to assemble the workpiece 20 or the presence or absence of such fasteners may be inspected.

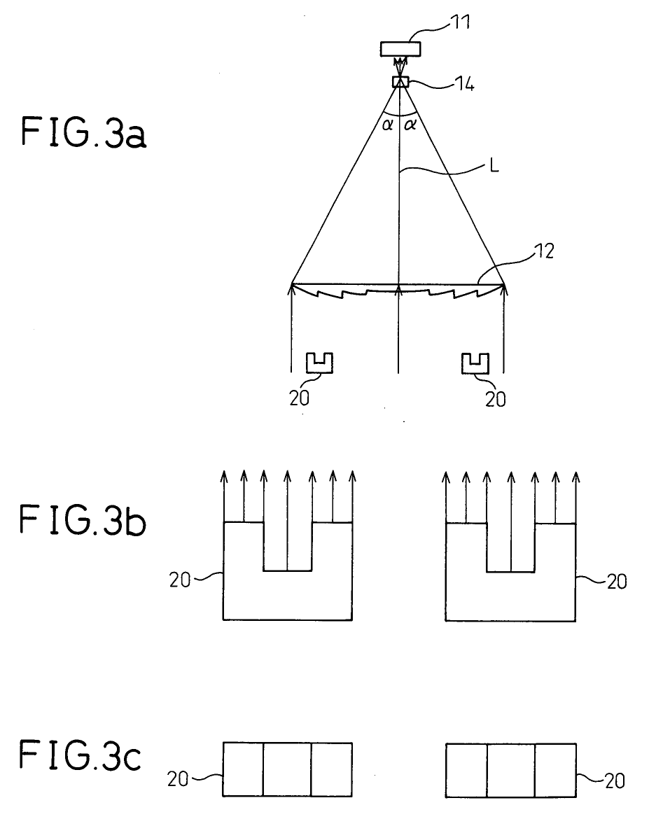

As shown in FIGS. 2 and 3, the workpiece 20 has a three-dimensional shape with a recessed portion in the center flanked on both sides by raised portions.

The apparatus 10 will be described below in further detail.

First, the one-dimensional imaging unit 11 will be described. The one-dimensional imaging unit 11 captures the image of the workpiece 20 as a series of image strips by incrementally scanning across the workpiece 20. The one-dimensional imaging unit 11 is constructed from a plurality of imaging elements arrayed in a straight line, and is generally known as a line sensor camera. Since each imaging element converts the incident light into an electrical signal for output, the one-dimensional imaging unit 11 captures a strip-like image per scan and outputs the resulting image signal to the image processing unit 16. As will be described in detail later, the one-dimensional imaging unit 11 captures a plurality of strip-like images by successively shooting the workpiece 20 being transported by the transport unit 15. The one-dimensional imaging unit 11 is controlled by the control unit.

Preferably, the number of imaging elements forming the one-dimensional imaging unit 11 is suitably selected according to the resolving power required to judge the quality acceptability of the workpiece 20. The number of imaging elements can be selected, for example, from the range of 5000 to 10000.

The one-dimensional imaging unit 11 is oriented so that the array of the imaging elements extends at right angles to the direction in which the workpiece 20 is transported by the transport unit 15. Here, the phrase “at right angles” means not only “exactly at right angles” but also “substantially at right angles.”

CCD or CMOS elements or the like can be used as the imaging elements. The one-dimensional imaging unit 11 may be a monochrome imaging type or a color imaging type.

Next, the first lens 12 will be described. The first lens 12 is a lens that causes parallel light incident in parallel to its optical axis to emerge as converging light, that is, a lens generally known as a convex lens. The first lens 12 is disposed between the workpiece 20 and the one-dimensional imaging unit 11 by aligning the optical axis of the first lens 12 so as to coincide with the optical axis of the one-dimensional imaging unit 11.

Here, the parallel light parallel to the optical axis of the first lens 12 refers to the light propagating toward the first lens 12 along its optical axis.

In the apparatus 10, the first lens 12 is specifically a Fresnel lens. As shown in FIG. 3a, the Fresnel lens is formed by cutting a convex lens into concentric circles to reduce the thickness required, and has a sawtooth-like cross section.

As shown in FIG. 2a, the first lens 12 is formed in the shape of an oblong plate, and the longitudinal direction of the first lens 12 coincides with the direction in which the imaging elements are arrayed in the one-dimensional imaging unit 11. That is, the longitudinal direction of the first lens 12 is oriented at right angles to the direction in which the workpiece 20 is transported by the transport unit 15. Here, the phrase “at right angles” means not only “exactly at right angles” but also “substantially at right angles.”

The component elements of the apparatus 10 are arranged so that the light emerging from any position located along the longitudinal length of the first lens 12 enters the one-dimensional imaging unit 11 via the second lens 14.

It is preferable that the longitudinal length of the first lens 12 is greater than the longitudinal length of the inspection portion of the workpiece 20 placed on the transport unit 15 of the apparatus 10. In other words, it is preferable that the dimension of the inspection portion of the workpiece 20, as measured in the direction at right angles to the transport direction of the workpiece 20 placed on the transport unit 15, that is, the longitudinal dimension of the inspection portion, is smaller than the longitudinal length of the first lens 12.

With this arrangement, the full length of the workpiece 20 placed on the transport unit 15, the full length extending in the longitudinal direction of the first lens 12, can be captured by the one-dimensional imaging unit 11.

Next, the pair of illumination units 13 and 13 will be described. As shown in FIG. 2a, each of the illumination units 13 and 13 has an oblong plate-like shape. Each illumination unit 13 has, on its surface facing the workpiece 20, light sources that are arrayed in a straight line along the longitudinal direction of the illumination unit 13. The light source array may consist of a single light source or more than one light source. Each illumination unit 13 can be constructed, for example, by arraying a plurality of LEDs along the longitudinal direction of the illumination unit 13.

As shown in FIGS. 2a and 2b, the pair of illumination units 13 and 13, whose longitudinal direction is oriented so as to coincide with the longitudinal direction of the first lens 12, is arranged between the first lens 12 and the workpiece 20 so as to illuminate the workpiece 20 obliquely from above. The two illumination units 13 and 13 are arranged parallel to each other. In the apparatus 10, the light emitted from the illumination units 13 and 13 and reflected by the workpiece 20 is used as the earlier described incident light from the workpiece 20.

Preferably, the pair of illumination units 13 and 13 is arranged to illuminate evenly at least a region P which is defined on the workpiece 20 by projecting the first lens 12 along the optical axis L, as shown in FIG. 2b. FIG. 2b is a side view showing a portion of the apparatus 10 when the pair of illumination units 13 and 13, etc. are viewed in the direction at right angles to the transport direction of the workpiece 20.

In the apparatus 10, the component elements are arranged so that any point in the region P on the surface of the workpiece 20 is focused through the optical focusing system onto the one-dimensional imaging unit 11.

As shown in FIG. 2b, the pair of illumination units 13 and 13 is arranged face down so that the light sources illuminate the workpiece 20 obliquely from above.

Further, the two illumination units 13 and 13 are spaced apart from each other by a distance greater than the width of the first lens 12 so that the field of view of the one-dimensional imaging unit 11 through the first lens 12 is not blocked by them. Here, the width of the first lens 12 is the dimension measured along a direction at right angles to the longitudinal direction of the first lens.

Next, the second lens 14 will be described. The second lens 14 is disposed with its optical axis aligned so as to coincide with the optical axes of the one-dimensional imaging unit 11 and the first lens 12. The second lens 14 is moved along its optical axis so that the lens is focused on the workpiece 20.

The workpiece 20 has three-dimensional raised and recessed portions, for example, as shown in FIGS. 2a and 3, and the focus must be adjusted according to the height of the workpiece surface. In the apparatus 10, by adjusting the position of the second lens 14, the lens can be focused on the portion of the workpiece 20 to be inspected.

The second lens 14 may be constructed from a single lens element or from a compound lens formed by combining a plurality of lens elements to correct for aberrations. The second lens 14 may be provided with a diaphragm. The diaphragm may be disposed between the first lens 12 and the second lens 14 or between the second lens 14 and the one-dimensional imaging unit 11.

Next, the transport unit 15 will be described. As shown in FIG. 2a, the transport unit 15 comprises a belt 15a on which the workpiece 20 is placed, a pair of drive rolls 15b and 15b for driving the belt 15a, and a pair of workpiece sensors 15c and 15c for sensing the workpiece placed on the belt 15a. A linear motor or a ballscrew mechanism may be used for the transport unit 15.

The transport unit 15 transports the workpiece 20 placed thereon, preferably in a direction transverse to or substantially at right angles to the direction in which the imaging elements of the one-dimensional imaging unit 11 are arrayed. In the apparatus 10, the transport unit 15 transports the workpiece 20 in the direction indicated by an arrow in FIG. 2, that is, substantially at right angles to the direction in which the imaging elements of the one-dimensional imaging unit 11 are arrayed. On the other hand, light such as infrared light is transmitted between the pair of workpiece sensors 15c and 15c. When the workpiece 20 placed on the belt 15a is transported and crosses the path between the pair of workpiece sensors 15c and 15c thus interrupting the light, the receiving workpiece sensor 15c outputs a sensor signal to the control unit. Upon receiving the sensor signal, the control unit causes the one-dimensional imaging unit 11 to start the image capturing operation by successive scanning.

Then, while the workpiece 20 is being transported in the transport direction by the transport unit 15, the one-dimensional imaging unit 11 captures a plurality of strip-like images each extending longitudinally in the direction substantially at right angles to the transport direction.

Preferably, the transport speed of the workpiece 20 on the transport unit 50 is suitably set according to the time required for the one-dimensional imaging unit 11 to scan the workpiece 20, the dimensions of the workpiece 20, the inspection accuracy required, etc. When shooting the entire surface of the workpiece 20 in a plurality of scans by the one-dimensional imaging unit 11, it is preferable to set the transport speed of the workpiece 20 so that the distance over which the workpiece 20 is transported during the time required for the one-dimensional imaging unit 11 to complete one scan becomes equal to or shorter than the length of the workpiece 20, measured along the transport direction, that is shot by that one scan.

Specifically, in the apparatus 10, the transport speed is set to 300 mm/second. Further, in the apparatus 10, the one-dimensional imaging unit 11 completes one scan in 500 microseconds, and one workpiece 20 is scanned 6000 times in succession for imaging.

The transport operation of the workpiece 20 by the transport unit 15 and the scanning operation of the one-dimensional imaging unit 11 may be synchronized to each other, and the transport of the workpiece 20 may be stopped when the one-dimensional imaging unit 11 is performing the scanning operation.

Next, the image processing unit 16 will be described. The image processing unit 16 includes an arithmetic unit, a storage unit, and an input/output unit not shown. The storage unit stores the images output from the one-dimensional imaging unit 11 and various programs such as an image processing program, a quality acceptability judging program, and programs for controlling or processing the various component elements of the apparatus 10. These programs are executed by the arithmetic unit. The control unit incorporated in the image processing unit 16 is implemented by the arithmetic unit executing the above programs. The input/output unit outputs the image captured by the one-dimensional imaging unit 11 or the result of the quality acceptability judgment to the display unit 17. Further, the input/output unit transfers control signals or data signals to and from the various component elements of the apparatus 10.

The image processing unit 16 receives each image signal as it is output from the one-dimensional imaging unit 11, and stores in the storage unit the plurality of strip-like images captured by the one-dimensional imaging unit 11. Next, from the plurality of images stored in the storage unit, the image processing unit 16 synthesizes an image representing the entire workpiece, and judges the quality acceptability of the workpiece 20 by using the synthesized image.

That is, the image processing unit 16 detects the workpiece 20 in the synthesized image, and judges the quality acceptability of the workpiece 20 by using the image of the detected workpiece 20. Various known methods can be used for the detection and quality acceptability judgment; for example, a normalized correlation matching method can be used. In the normalized correlation matching method, a defect-free workpiece image pattern representing a defect-free workpiece 20 is prestored in the storage unit, and the image captured by the one-dimensional imaging unit 11 is compared with the defect-free workpiece image pattern.

More specifically, in the normalized correlation matching method, a defect-free workpiece image pattern called a master image is preregistered, and the synthesized image containing the workpiece 20 is searched, starting from the upper left corner of the image and working toward the lower right corner, to obtain the correlation value (a measure of the degree to which the input image matches the master image) at each designated position. Then, the quality acceptability of the workpiece 20 is judged according to whether or not the correlation value at the position where the obtained correlation value is the greatest exceeds a predetermined threshold value. Here, the correlation value is obtained as a value that falls within a range between −1 and 1. In the apparatus 10, if the correlation value exceeds the predetermined threshold value, the quality of the workpiece 20 is judged to be acceptable.

The image processing unit 16 can be implemented using known technology; for example, a sequence control apparatus or a personal computer may be used.

Further, any known display device, such as a liquid crystal display, a CRT, or a PDP, can be used as the display unit 17. Each component element of the apparatus 10 is fixedly supported by a supporting member not shown.

Next, referring to FIGS. 3a to 3c, a description will be given of how the apparatus 10 having the above-described configuration can accurately inspect the surface of the workpiece 20 having a three-dimensional shape containing raised and recessed portions.

As shown in FIG. 3a, the one-dimensional imaging unit 11 has a field of view, α, centered about the optical axis L via the second lens 14. The first lens 12 is placed with its longitudinal ends located at the boundary of the field of view of the one-dimensional imaging unit 11. The one-dimensional imaging unit 11 is set so that all the light emerging from the first lens 12 is focused on the one-dimensional imaging unit 11. That is, the light emerging from any position located along the longitudinal length of the first lens 12 is made to converge through the second lens 14 toward the one-dimensional imaging unit 11, and enters the one-dimensional imaging unit 11 for imaging.

Further, in FIG. 3a, a pair of workpieces 20 and 20 are placed near the left and right edges, respectively, of the region P (see FIG. 2b).

In the apparatus 10, as shown in FIGS. 3a and 3b, the chief ray of the bundle of rays leaving each workpiece 20 and incident on the first lens 12 is parallel to the optical axis of the first lens 12. As a result, the light reflected from any portion in the region P (see FIG. 2b) of the workpiece 20 and incident on the first lens 12 is focused through the second lens 14 onto the one-dimensional imaging unit 11. In FIG. 3b, the directions of the chief rays of the bundles of rays leaving the respective workpieces 20 and directed to the first lens 12 are indicated by arrows.

Accordingly, in the apparatus 10 which captures an image by successively scanning across the workpiece 20 being transported by the transport unit 15, all the portions of the workpiece 20 that face the first lens 12 can be captured by the one-dimensional imaging unit 11, as shown in FIG. 3c.

In this way, according to the apparatus 10, the entire surface of the workpiece 20 having a three-dimensional shape with raised and recessed portions can be captured by the one-dimensional imaging unit 11, as shown in FIG. 3c, since there are no portions that are blocked by the raised portions.

Further, at whatever position the workpiece 20 is placed on the transport unit 15, all the portions of the workpiece 20 that face the first lens 12 can likewise be captured by the one-dimensional imaging unit 11, as shown in FIGS. 3a to 3c.

The one-dimensional imaging unit 11 used in the apparatus 10 has the following advantages over a surface inspection apparatus having, for example, a two-dimensional imaging unit. The two-dimensional imaging unit here refers to an imaging unit in which the imaging elements are arranged in two dimensions.

(1) It becomes easier to adjust the optical axis.

(2) The size of the apparatus 10 can be reduced by reducing the size of the imaging unit.

(3) The manufacturing cost of the apparatus 10 can be reduced.

(4) It becomes easier to obtain an imaging unit having high resolving power.

Further, since the first lens 12 is formed in an oblong shape to match the shape of the one-dimensional imaging unit 11, the apparatus 10 has the following advantage over the surface inspection apparatus having a two-dimensional imaging unit.

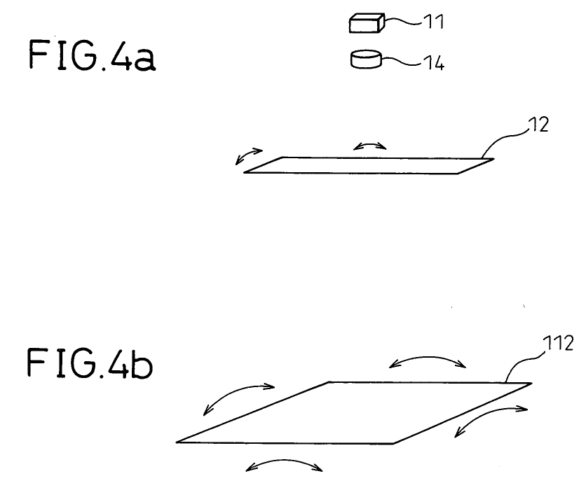

That is, since the amount of deflection of the first lens 12 is small in both the longitudinal and crosswise directions, as shown in FIG. 4a, the image captured by the one-dimensional imaging unit 11 is less susceptible to distortion associated with such deflection. On the other hand, the surface inspection apparatus having a two-dimensional imaging unit requires the use of a first lens 112 having a large two-dimensional area, as shown in FIG. 4b, and as a result, the amount of deflection is large in both the longitudinal and crosswise directions, and the distortion of the captured image increases due to the deflection.

Further, in the apparatus 10 having the one-dimensional imaging unit 11, since the area of the region P (see FIG. 2b) is small, the region P can be evenly illuminated by the pair of illumination units 13 and 13. On the other hand, in the surface inspection apparatus having a two-dimensional imaging unit, since the area to be illuminated is large, it is difficult to illuminate the area evenly, and the unevenness of the illumination affects the captured image.

As described above, compared with the surface inspection apparatus having a two-dimensional imaging unit, the apparatus 10 having the one-dimensional imaging unit 11 can capture an accurate image of the workpiece 20 and can therefore correctly judge the quality acceptability of the workpiece 20 based on the captured image.

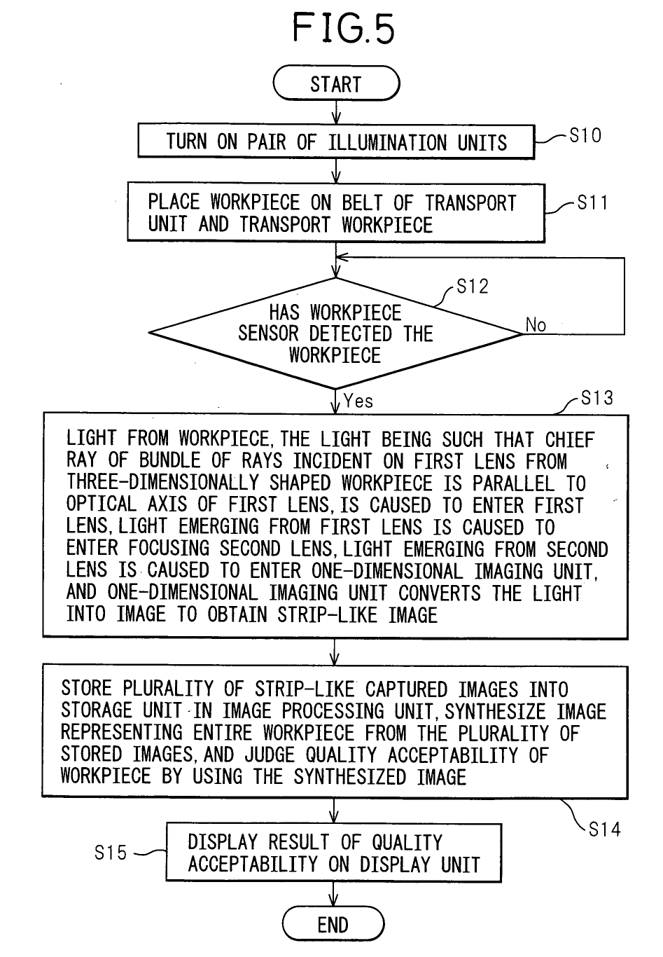

Next, an operational example of the above-described apparatus 10 will be described with reference to FIG. 5. The operation is performed primarily by the arithmetic unit in the image processing unit 16 executing a designated program stored in the storage unit.

First, in step S10, the pair of illumination units 13 and 13 are turned on.

Next, in step S11, the workpiece 20 is placed on the belt 15a of the transport unit 15 to start the transport of the workpiece 20.

Next, in step S12, it is checked whether the workpiece sensor 15c has detected the workpiece 20. If the workpiece sensor 15c has not yet detected the workpiece 20, the process returns to the step before step S12. On the other hand, if the workpiece sensor 15c has detected the workpiece 20, the process proceeds to step S13.

In step S13, the light from the workpiece 20 being transported by the transport unit 15, the light being such that the chief ray of the bundle of rays incident on the first lens 12 from the three-dimensionally shaped workpiece 20 is parallel to the optical axis of the first lens 12, is caused to enter the first lens 12, the light emerging from the first lens 12 is caused to enter the focusing second lens 14, the light emerging from the second lens 14 is caused to enter the one-dimensional imaging unit 11, and the one-dimensional imaging unit 11 converts the light into an image, thus obtaining a strip-like image. Then, the one-dimensional imaging unit 11 outputs each of the thus obtained images to the image processing unit 16.

Next, in step S14, the image processing unit 16 stores the plurality of strip-like captured images into the storage unit in the image processing unit, synthesizes an image containing the entire workpiece 20 from the plurality of stored images, and judges the quality acceptability of the workpiece 20 by using the synthesized image.

After that, in step S15, the image processing unit 16 displays the judgment result of the quality acceptability of the workpiece 20. If there is another workpiece 20 to be inspected, the process may be repeated starting from step S11.

The apparatus 10 may be installed for the in-line surface inspection of the workpiece 20 in the manufacturing process of the workpiece 20. In that case, any workpiece judged to be defective can be quickly removed from the manufacturing process.

According to the above-described apparatus 10, any workpiece 20 having a three-dimensional shape with raised and recessed portions can be accurately inspected. Furthermore, the surface of the three-dimensionally shaped workpiece 20 can be inspected in a reliable manner without being affected by the position at which the workpiece 20 is placed. Furthermore, the use of the one-dimensional imaging unit 11 not only facilitates the adjustment of the optical axis, but also serves to reduce the manufacturing cost of the apparatus while reducing the size of the imaging unit. Moreover, it becomes easier to obtain an imaging unit having high resolving power.

Further, since the apparatus 10 is equipped with two illumination units 13 and 13 so as to be able to evenly illuminate the workpiece 20, the workpiece 20 having a three-dimensional shape with raised and recessed portions can be inspected further accurately.

Furthermore, since the first lens 12 used in the apparatus 10 is constructed from a Fresnel lens, the lens is lightweight and easy to handle, so that it is easy to adjust the optical axis. Further, the use of the Fresnel lens, which is inexpensive compared with a conventional convex lens, serves to reduce the manufacturing cost.

In the apparatus 10, since the optical axis of the one-dimensional imaging unit 11 is aligned so as to coincide with the optical axis of the first lens 12, there is no need to provide, for example, means for reflecting the light emerging from the first lens 12; as a result, the surface inspection apparatus can be constructed with a reduced number of optical elements.

Furthermore, in the apparatus 10, since one synthesized image is created from the plurality of high-resolution strip-like images, the workpiece 20 can be inspected highly accurately by using the high-resolution synthesized image.

The surface inspection apparatus and method of the present invention is not limited to the above particular embodiment, but can be suitably modified without departing from the spirit of the present invention.

For example, in the above embodiment, a Fresnel lens has been used as the first lens, but instead, a conventional convex lens or a lens formed by longitudinally cutting a circular convex lens may be used.

In the above embodiment, the optical axis of the one-dimensional imaging unit 11 has been aligned to coincide with the optical axis of the first lens 12, but these optical axes need not necessarily be made to coincide with each other. In that case, the light emerging from the first lens 12 may be reflected or refracted using an optical element so that the reflected or refracted light is incident on the one-dimensional imaging unit 11 for imaging.

The object to be inspected by the surface inspection apparatus of the present invention may be an automotive component. Such automotive components include, for example, an electric fan of a radiator or cooling fan and the like.

What is claimed is:

1. An inspection apparatus comprising:
a one-dimensional imaging unit for imaging a three-dimensionally shaped test object;
a first lens for causing light incident thereon from said test object to emerge as converging light; and
a second lens, disposed between said first lens and said one-dimensional imaging unit, for focusing the light emerging from said first lens, wherein
a chief ray of a bundle of rays incident on said first lens from said test object is parallel to an optical axis of said first lens, and
said light containing said chief ray, incident from said test object, is focused through said first lens and said second lens onto said one-dimensional imaging unit for imaging.

2. An inspection apparatus as claimed in claim 1, wherein said first lens is a Fresnel lens.

3. An inspection apparatus as claimed in claim 1, wherein said one-dimensional imaging unit is constructed from a plurality of imaging elements arrayed in a straight line, and
said first lens is formed in an oblong shape whose longitudinal length extends in a direction that coincides with the direction in which said plurality of imaging elements are arrayed in said one-dimensional imaging unit.

4. An inspection apparatus as claimed in claim 3, wherein the longitudinal length of said first lens is greater than the longitudinal length of an inspection portion of said test object placed on said surface inspection apparatus.

5. An inspection apparatus as claimed in claim 4, further comprising a pair of illumination units each having an oblong shape, and wherein
said pair of illumination units, whose longitudinal direction is oriented so as to coincide with the longitudinal direction of said first lens, is arranged between said first lens and said test object so as to illuminate said test object obliquely from above.

6. An inspection apparatus as claimed in claim 5, further comprising a transport unit for transporting said test object placed thereon, and wherein
said transport unit transports said test object in a direction transverse to the direction in which said plurality of imaging units are arrayed, and
said one-dimensional imaging unit successively captures images of said test object being transported.

7. An inspection apparatus as claimed in claim 1, wherein an optical axis of said one-dimensional imaging unit coincides with said optical axis of said first lens.

8. An inspection method, wherein
light from a three-dimensionally shaped test object, said light being such that a chief ray of a bundle of rays incident on a first lens from said test object is parallel to an optical axis of said first lens, is caused to enter said first lens which causes the light incident thereon from said test object to emerge as converging light,
the light emerging from said first lens is caused to enter a focusing second lens,
the light emerging from said second lens is caused to enter a one-dimensional imaging unit,
the light entering said one-dimensional imaging unit is converted into an image, and
quality acceptability of said test object is judged by using said image captured by said one-dimensional imaging unit.

9. An inspection method as claimed in claim 8, wherein
an image representing the entirety of said test object is synthesized from a plurality of strip-like images captured by said one-dimensional imaging unit, and the quality acceptability of said test object is judged by using said synthesized image.
